(19) United States
(12) Patent Application Publication
(10) Pub. No.: US 2016/0009455 A1
(43) Pub. Date: Jan. 14, 2016

(54) BAG AND FLUID DISCHARGE METHOD USING THE SAME

(71) Applicant: HOSOKAWA YOKO CO., LTD., Tokyo (JP)

(72) Inventors: Hiroo NAKANO, Tokyo (JP); Katsuyuki YOSHIKAWA, Tokyo (JP)

(21) Appl. No.: 14/772,530

(22) PCT Filed: Feb. 26, 2014
(86) PCT No.: PCT/JP2014/054709

§ 371 Date: Sep. 3, 2015

(30) Foreign Application Priority Data
Mar. 4, 2013 (JP) 2013-041791

(51) Int. Cl. B65D 35/08; B65D 33/16; A61J 1/14; B65D 35/12; A61J 1/10; B65D 33/01; B65D 33/14

(52) U.S. Cl. CPC B65D 35/08; B65D 33/01; B65D 33/1691; B65D 33/14; B65D 35/12; A61J 1/10; A61J 1/1462; A61J 1/1475

(57) ABSTRACT

Disclosed is a bag comprising a bag-shaped container body which is made of a flexible film, and a spout tube which allows the inside of the container body to communicate with the outside the container body, wherein the container body comprises: a cylindrical barrel portion; a first sealing part which is formed at a lower end of the barrel portion by matching and sealing together inner surfaces of the film constituting the container body; and a flat bottom face part including an upper end edge of the first sealing part; wherein the spout tube is interposed between the films that are matched at the first sealing part of the bottom face part; and wherein the first sealing part and the spout tube are disposed in a plane which is approximately parallel to the flat bottom face part.

### TECHNICAL FIELD

The present invention relates to a bag comprising a spout tube and a press-deformable container body, and a method for discharging a fluid using the bag.

### BACKGROUND ART

In general, as a method for discharging a liquid by pressure, one method is used in such a way that a pressure container such as a metal container made of iron or stainless, or a plastic container designed for withstanding pressure is directly filled with a liquid and the liquid is discharged. However, these containers are necessary to be washed each time of use for sufficiently eliminating the residue inside of the container, so those works are undesirable since they are sometimes complicated and require the time and labor. For example, if a liquid composition such as glue, coating material, adhesive or coating agent is dried or cured while the liquid composition remains in the container, it is not easy to be removed, so that more complicated work is required. To avoid such a complexity of the work, in recent years, there has been started to use a method that a disposable plastic bag is filled with a liquid and the liquid is discharged by applying pressure from the outside of the plastic bag in the pressure container.

In the pharmaceutical industry, in recent years, when a large amount of pharmaceutical products or materials for various inspection is transferred to the next step in a solution state, the transfer such that those materials are discharged using the pressure container has become frequent. The cross contamination of pharmaceutical products absolutely must be avoided, so that washing inside of the pressure container is extremely important and it is necessary to prove no cross contamination by performing validation of washing, etc. In view of the above circumstances, in the pharmaceutical industry, the method has been started to be employed, the method comprising the steps of: performing the transfer such that a single-use plastic bag is used, and materials are discharged by applying pressure from the outside of the plastic bag in the pressure container; and disposing the used plastic bag as it is.

The method of discharging a liquid using a bag arranged in a pressure container is classified roughly into a method in which a liquid discharge port is provided on the upper portion of the bag as disclosed in Patent Literature 1, and a method in which a liquid discharge port is provided on the lower side of the bag as disclosed in Patent Literature 2.

### CITATION LIST

Patent Literature 1: Japanese Patent Application Laid-Open (JP-A) No. 2012-188167

Patent Literature 2: JP-A No. 2004-174468

### SUMMARY OF INVENTION

### Technical Problem

In the method disclosed in Patent Literature 1, to discharge a liquid without clogging, a long flow passage member is extended from the upper portion of the bag to around the bottom of the bag, and an opening is further provided on the side of the long flow passage member. However, in this method, it is difficult to discharge the liquid remaining in the bottom of the bag to the end.

On the other hand, in the method disclosed in Patent Literature 2, since a spout is provided on the bottom of a container for a viscous product, the amount of a liquid remaining on the bottom of the container can be somewhat decreased. However, in the method disclosed in Patent Literature 2, a spout is connected to the lower end of the container for the viscous product downward in a vertical direction, so that the viscous product is discharged in a downward direction from the bottom of the container for the viscous product. Therefore, with the decrease in the amount of the viscous product in the container for the viscous product, the tension of the container is lost compared to that when the container is full, and thus the container for the viscous product is hung down around the spout; thereby there are disadvantages that the liquid accumulated on the position below the spout opening is not eventually discharged and remains. In that case, since the spout opening connecting to the lower end in the container for the viscous product is upward in a vertical direction, there is a possibility that film materials having flexibility which form the container for the viscous product clog the spout opening. Further, according to FIG. 1 of Patent Literature 2, the direction of the flow passage of the viscous product is changed to a horizontal direction with joint 17 after the viscous product is discharged downward in a vertical direction from the lower portion of the container for the viscous product, and the direction is further changed upward in a vertical direction using flexible horse 16. Since the travelling direction of the viscous product is changed twice as described above, there is a concern that the content remains in a direction changing part and thus the clog of the flow passage is caused. Furthermore, according to FIG. 1 of Patent Literature 2, the container for the viscous product is hung inside of the pressure container, so that the container for the viscous product cannot be mounted inside of the pressure container due to its structure.

The present invention was achieved in light of the above circumstances. An object of the present invention is to provide: a bag which is configured so that a discharge port and a flow passage are not clogged when discharging a fluid, and an extremely small amount of the fluid remains in a container body after the discharge; and a fluid discharge method using the bag.

### Solution to Problem

The bag of the present invention comprises a bag-shaped container body which is made of a flexible film, and a spout tube which allows the inside of the container body to communicate with the outside the container body,

wherein the container body comprises: a cylindrical barrel portion; a first sealing part which is formed at a lower end of the barrel portion by matching and sealing together inner surfaces of the film constituting the container body; and a flat bottom face part including an upper end edge of the first sealing part;

wherein the spout tube is interposed between the films that are matched at the first sealing part of the bottom face part; and

wherein the first sealing part and the spout tube are disposed in a plane which is approximately parallel to the fiat bottom face part.

In the bag of the present invention, the first sealing part is preferably folded in approximately parallel to the bottom face part.

In the bag of the present invention, the flat bottom face part is preferably formed by folding a lower end of the barrel portion so as that an inner surface of a side edge of the barrel portion and an inner surface in the vicinity of the upper end edge of the first sealing part are in contact with each other and providing a second sealing part which is fixed in a folded state.

Especially in such a structure, a sealing direction of the second sealing part is preferably approximately vertical to a sealing direction of the first sealing part.

In the bag of the present invention, the barrel portion is preferably made of a seamless integrally-molded film.

In the bag of the present invention, the spout tube is preferably provided approximately at the middle in a container body width direction of the first sealing part.

The fluid discharge method of the present invention comprises the steps of: filling the bag with a fluid; disposing the bag so that the bottom face part of the bag is arranged on the lower side of a vertical direction in a pressure container, and an end of the spout tube or an end of an extension tube which is connected to the spout tube is drawn out to the outside of the pressure container; and applying pressure from the outside of the bag by applying pressure to the inside of the pressure container, thus discharging the fluid from the bag to the outside of the pressure container.

### Advantageous Effects of Invention

According to the present invention, the container body has a flat bottom face part, and the spout tube is arranged in approximately parallel to the flat surface of the bottom face part in the container body, so that a space for arranging the spout tube downward below the bag is not necessary; therefore, a flexible film which forms the container body is not hung down and dropped. Thereby, no content remains on the lower side of the flow passage inlet of the spout tube being a discharge port inside of the container body, and thus the amount of the content remaining after discharge can be decreased compared to that in the conventional container for a viscous product. Also, according to the present invention, the spout tube is arranged in approximately parallel to the flat surface of the bottom face part, so that an opening direction of the flow passage inlet of the spout tube inside of the container body is not upward. Therefore, in the last stage of the content discharge, the spout tube is prevented from being covered with the container body which is sagged by gravity from the upper side. In addition to that, when the bag of the present invention is arranged inside of the pressure container, the number of the direction changes of the content flow passage extending from the bag can be decreased. Thereby, the clog of the flow passage, which is caused by the content remaining at a direction changing part, can be avoided.

### BRIEF DESCRIPTION OF DRAWINGS

FIG. 1 is a perspective view showing an embodiment of a bag (bag 100) of the present invention.

FIG. 2 is a perspective view of a bottom face part of bag 100 in FIG. 1.

FIG. 3 is a bottom view of bag 100 in FIG. 1.

FIG. 4 is a back view of a bottom face part of bag 100 in FIG. 1.

FIG. 5 (a) is another embodiment of the bag of the present invention, and is a bottom view showing an embodiment having a trapezoidal bottom face part in which a side of a front side is longer than that of a back side.

FIG. 5 (b) is another embodiment of the bag of the present invention, and is a bottom view showing an embodiment having a trapezoidal bottom face part in which a side of a front side is shorter than that of a back side.

FIG. 5 (c) is another embodiment of the bag of the present invention, and is a bottom view showing an embodiment having an approximately circular bottom face part.

FIG. 5 (d) is another embodiment of the bag of the present invention, and is a bottom view showing an embodiment having a bottom face part in which the whole face of corner portions are sealed.

FIG. 6 is a cross-sectional view of the bottom face part of bag 100 in FIG. 1 cut along a line A-A.

FIG. 7 (a) is a schematic view of cylindrical body 100a made of a flexible film.

FIG. 7 (b) is a schematic view of intermediate product 100b in a typical example of the method for producing a bag of the present invention.

FIG. 8 is a part of a magnified view of a front face of a lower side of the barrel portion of intermediate product 100b.

FIG. 9 (a) is a part of a magnified view of a front face of a lower side of the barrel portion showing a state in which intermediate product 100b in FIG. 8 is folded according to positioning points.

FIG. 9 (b) is a part of a perspective view of a lower side of the barrel portion showing a state in which intermediate product 100b of FIG. 8 is folded according to positioning points.

FIG. 10 is a schematic perspective view showing an embodiment of a fluid discharge method of the present invention.

### DESCRIPTION OF EMBODIMENTS

### 1. Bag

The bag of the present invention comprises a bag-shaped container body which is made of a flexible film, and a spout tube which allows the inside of the container body to communicate with the outside the container body,

wherein the container body comprises: a cylindrical barrel portion; a first sealing part which is formed at a lower end of the barrel portion by matching and sealing together inner surfaces of the film constituting the container body; and a flat bottom face part including an upper end edge of the first sealing part;

wherein the spout tube is interposed between the films that are matched at the first sealing part of the bottom face part; and

wherein the first sealing part and the spout tube are disposed in a plane which is approximately parallel to the flat bottom face part.

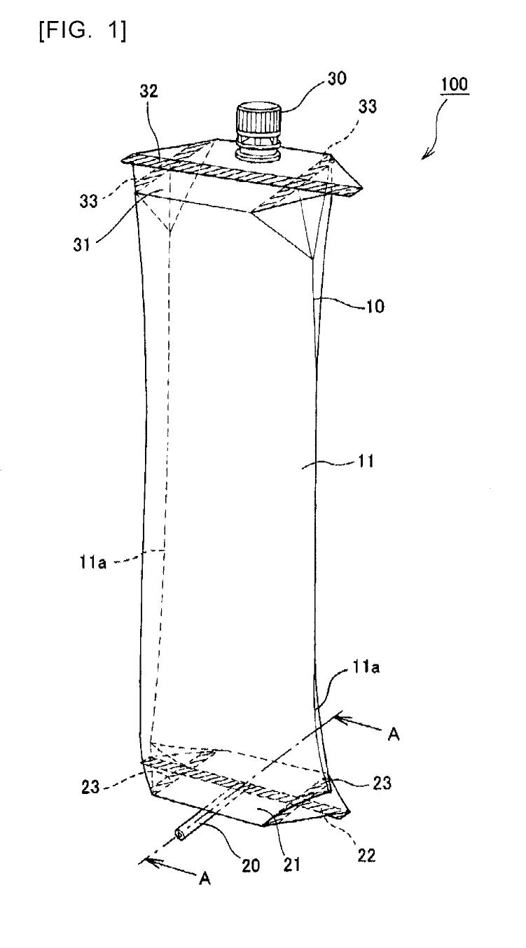

Hereinafter, the bag of the present invention will be explained with reference to FIGS. 1 to 10. Those shown in the Figs are one example of the bag of the present invention, and the present invention is not limited thereto.

In FIGS. 1 to 10, hatching sections show seal sections of each of constituting members (the first to fourth sealing parts).

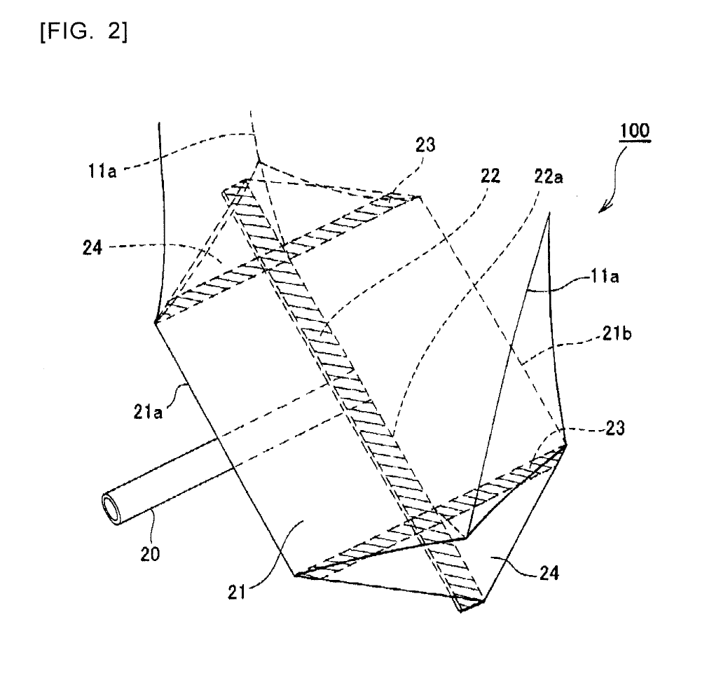

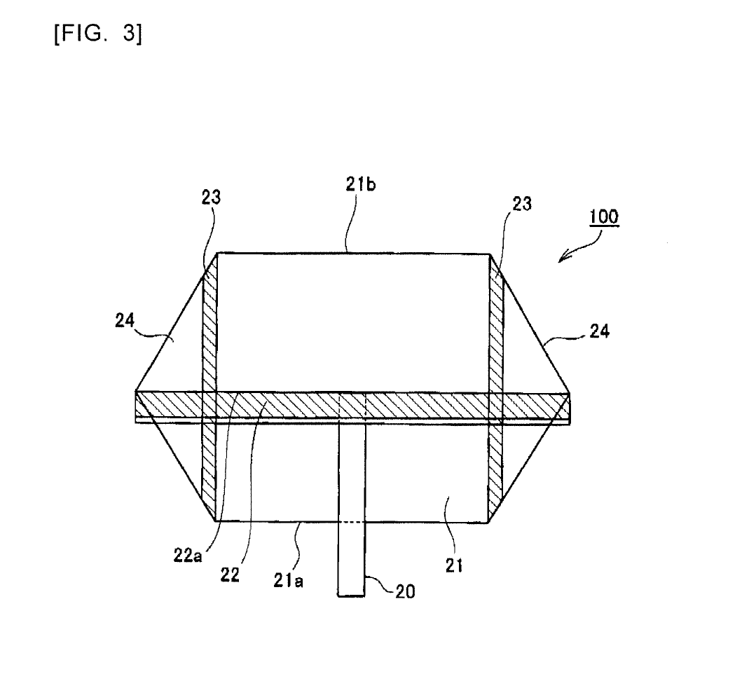

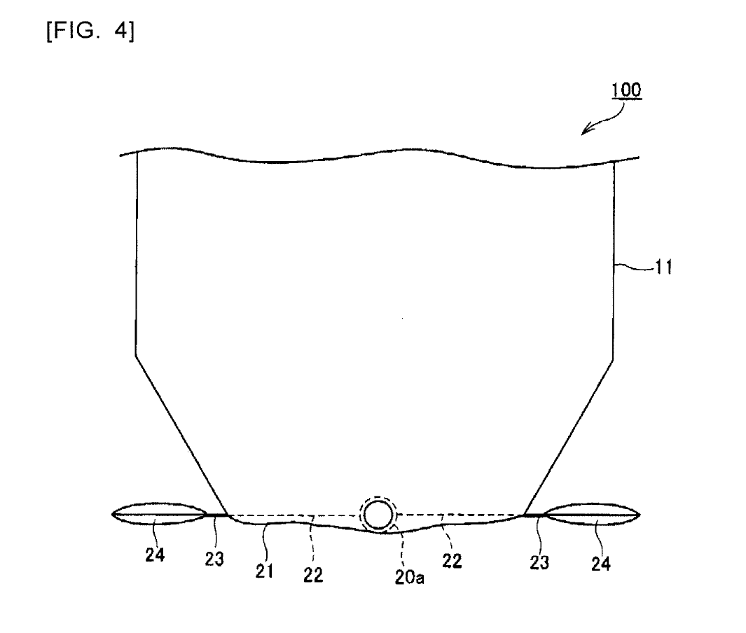

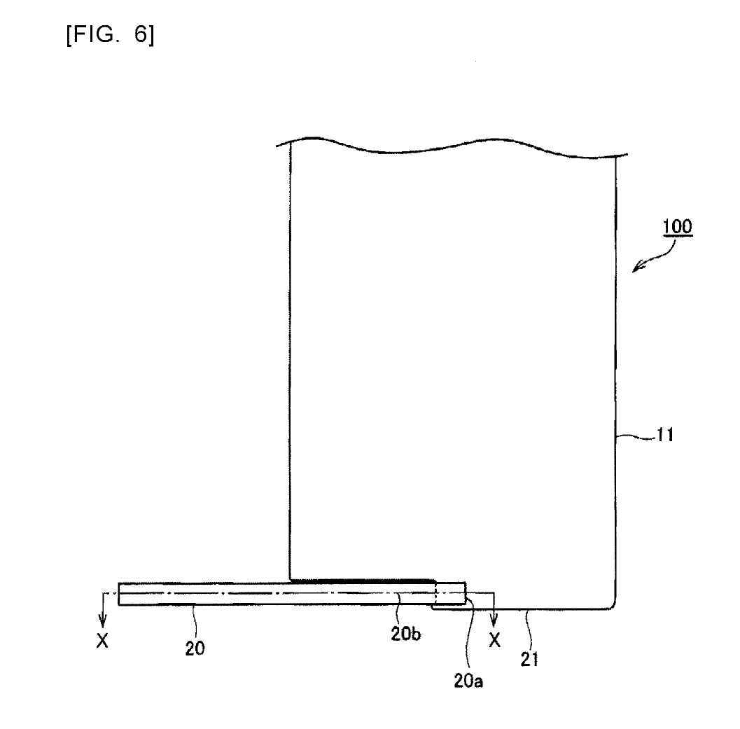

FIG. 1 is an embodiment of the bag of the present invention, and is a perspective view of bag 100. FIG. 2 is a perspective view of a bottom face part of bag 100, and FIG. 3 is a bottom view of bag 100. FIG. 4 is a back view of a bottom face part of bag 100, and FIG. 6 is a cross-sectional view of the flat bottom face part of bag 100 cut along a line A-A.

As shown in FIG. 1, bag 100 comprises bag-shaped container body 10, spout tube 20 which allows the inside of container body 10 to communicate with the outside container body 10, and inlet 30.

Container body 10 of bag 100 comprises barrel portion 11 whose cross sectional shape is an approximately elliptic cylindrical shape, and comprises flat bottom face part 21 on one end of the barrel portion 11, and flat upper face part 31 on the other end of barrel portion 11, respectively. Spout tube 20 is provided on the flat bottom face part 21. Spout tube 20 and first sealing part 22 are arranged in a plane which is approximately parallel to flat bottom face part 21, and the outer surface of spout tube 20 is arranged so as to be adjacent to flat bottom face part 21.

On the flat upper face part 31, inlet 30 is provided so as to face upward and be approximately parallel to the axial direction of the barrel portion. Hereinafter, in bag 100, the side in which the spout tube is projected is defined as the front face of the bag, and the other side is defined as a back face.

### 1-1. Container Body

The bag-shaped container body of the present invention is made of a flexible film, and comprises at least a cylindrical barrel portion, a first sealing part formed by sealing the lower end of the barrel portion, and a flat bottom face part.

In FIG. 1 and FIG. 2, when attention is focused on the lower side of barrel portion 11 of container body 10 in bag 100, the inner surfaces of side edges 11a of the barrel portion in container body 10 are folded so as to contact with the inner surface in the vicinity of the upper end edge 22a of the first sealing part. Herein, the upper end edge 22a of the first sealing part refers to a boundary between the inside of the container body 10 and the first sealing part 22. The overlapped part obtained by folding is fixed in a folded state by forming second sealing part 23 so as to be approximately vertical to a seal direction of the first sealing part 22. As shown in FIG. 1 and FIG. 2, a flat bottom face part 21 is formed by intersecting the first sealing part 22 and the second sealing part 23.

In the upper end of barrel portion 11 of container body 10 in bag 100, third sealing part 32 is provided so that the seal direction of third sealing part 32 is approximately parallel to that of first sealing part 22. Similarly as second sealing part 23 at the lower side of barrel portion 11, fourth sealing part 33 is provided at the upper side of barrel portion 11, thereby flat upper face part 31 is formed.

The methods for forming a bottom face part and an upper face part will be explained in detail in “1-4. Production method of bag”.

The cylindrical barrel portion made of a flexible film is preferably made of a seamless integrally-molded film. The cylindrical body made of the seamless integrally-molded film is suitably formed by inflation molding, blow molding and the like. Among them, for the bag-shaped container body of the present invention, a seamless film molded by inflation molding is more preferably used.

The cylindrical barrel portion made of the flexible film may be formed by bonding both edges of a piece of a flexible film. When a seal section is provided at the side portion of the cylindrical barrel portion made of the flexible film, the strength of the side portion may decrease when folding the cylindrical barrel portion made of the flexible film; therefore, when the cylindrical barrel portion is formed by bonding both edges of a piece of a flexible film, it is preferable that the seal section is formed not at the side portion, but at back face portion or front face portion of the cylindrical barrel portion made of a flexible film.

The material of the flexible film which forms a container body is not particularly limited, as long as it can seal contents and form a bag, and may be a single layer film or a multi-layer film.

When a single layer film is used as the flexible film, generally heat-sealable resins such as polyethylene and polypropylene, and a copolymer resin mainly containing these resins are preferably used. Also, a single layer film containing a plurality of types of these resins may be used.

When a multi-layer film is used as a flexible film, at least the innermost layer (that is, a layer which contacts with the content such as a fluid) is preferably one of the above-mentioned heat-sealable resin groups. The multi-layer film used in the present invention may be a multi-layer film molded by coextrusion with different resins, or a bonded multi-layer film produced by adhesion or the similar method.

When the multi-layer film is used, from the point of view that the direction of a spout tube keeps approximately parallel to the flat face of the bottom face part of the container body, the container body preferably has a slight rigidity in the range that the outermost layer has flexibility as a bag container. Concrete example of the case where rigidity is imparted to the container body is such that a resin having high rigidity is used. If a type of the resin is limited, there may be mentioned an example that rigidity is imparted by increasing density, crystallinity and molecular weight of the resin.

Examples of the resin which is generally regarded as having high rigidity include polyacetal, polyoxymethylene, polysulfone, polyphenylene ether, polybutylene terephtalate, polyethylene terephtalate, polymethylmethacrylate, polystyrene and polyamide, which are called engineering plastic. Among them, polyethylene terephtalate and polyamide are preferable.

In the case of polypropylene and polyethylene which are generally used as a resin applicable to heat-sealing of a bag as an innermost layer when using a single layer film or a multi-layer film, if the density, crystallinity and molecular weight thereof are high, rigidity of the container body can be increased. An example of polyethylene having high density includes high density polyethylene having a density of 0.942 g/cm³ or more defined in JIS K6748:1995. In polyethylene, the density is generally in direct proportion to crystallinity, so that the higher the density, the higher the crystallinity. The crystallinity of polyethylene is preferably 30% or more.

The above-mentioned materials are merely exemplified, and the materials of the flexible film used for the container body of the present invention are not limited thereto. Also, when the multi-layer film is used, in addition to the outermost layer and the innermost layer, an intermediate layer can be used therebetween.

The thickness of the flexible film which forms a container body of the present invention is not particularly limited. When the content such as a fluid is discharged by applying pressure, from the point of view that the film withstands the pressure and the weight of content, the thickness is preferably 50 μm or more, more preferably 100 μm or more. By satisfying the above thickness specification, rigidity of the container body increases, and the direction of the spout tube can keep approximately parallel to a flat face of the bottom face part. On the other hand, from the viewpoint of deformation mainly upon pressure, the thickness of the flexible film is preferably 2,000 μm or less, more preferably 1,500 μm or less.

The cross sectional shape of the barrel portion of the container body in the present invention is not particularly limited, for example, approximately circular shape, approximately elliptic shape and polygonal shapes such as tetragon can be exemplified. The cross sectional shape of the barrel portion may be varied in line with the axial direction of the barrel portion.

The axial direction length of the barrel portion of the container body in the present invention can be appropriately adjusted depending on the usage, for example, it can be set to 100 to 10,000 mm.

The barrel portion width of the container body in the present invention refers to a width of the folded barrel portion. The width of the folded barrel portion is specifically defined by the folded width in the case of an approximately cylindrical barrel portion. In the case of the barrel portion having a side face portion like a gusset type barrel portion, the width is defined by a width of the front face portion or a width of the back face portion. The barrel portion width of the container body in the present invention can be appropriately adjusted depending on the usage, for example, it can be set to 10 to 2,000 mm.

The capacity of the container body in the present invention can be appropriately adjusted similarly as the above dimension, for example, it can be set to 0.01 to 5,000 L.

### (A) The First Sealing Part

The first sealing part of the container body in the present invention is a part which is formed at a lower end of the barrel portion by matching and sealing together inner surfaces of the film constituting the container body. Further, the first sealing part is folded parallel to the below described flat face of the bottom face part.

The shape of the first sealing part is not particularly limited, as long as it is a shape in which the content is not leaked except a spout tube. The examples include a linear shape, a wavy-lined shape, etc. Also, several number of the first sealing part can be provided at the lower end of the barrel portion.

From the viewpoint of preventing the leakage of content, the seal width of the first sealing part is preferably 1 mm or more, more preferably 5 mm or more. On the other hand, from the viewpoint of yield of the flexible film, the seal width of the first sealing part is preferably 30 mm or less, more preferably 20 mm or less.

The first sealing part can be provided in the range of 0 mm or more and 5 mm or less from the lower end of the barrel portion.

### (B) Bottom Face Part

The bottom face part of the container body in the present invention is a flat portion containing the upper end edge of the above-described first sealing part.

As shown in FIG. 2 and FIG. 3, bottom face part 21 of bag 100 is a tetragon made up of two second sealing part 23 which oppose each other, and side 21a and side 21b which oppose each other. Herein, side 21a is a side which can be a boundary of the lower portion of the front face of the barrel portion and bottom face part 21, side 21b can be a side which can be a boundary of the lower portion of the back face of the barrel portion and bottom face part 21. As shown in FIG. 2 and FIG. 3, upper end edge 22a of the first sealing part is located inside of the bottom face part 21 of bag 100. As shown in FIG. 2 and FIG. 3, the seal direction of the second sealing part 23 is approximately vertical to the seal direction of the first sealing part 22.

As shown in FIG. 2 and FIG. 4, in the container body width direction, triangle corner portions 24 are respectively formed at each side of bottom face part 21 interposing the second sealing parts 23. The internal space of each of corner portions 24 is isolated from the internal space of the container body by second sealing parts 23.

As described above, it is preferable that the seal direction of the second sealing part is approximately vertical to the seal direction of the first sealing part. As just described, predetermined angle is provided between the seal directions of both of the seal parts, and these seal parts are functioned as so-called beam, so that the bottom face part can be kept in a flat face. Herein, “the seal directions of both of the seal parts are approximately vertical” means that the angle formed by the seal directions of both of the seal parts is preferably 70 to 110°, more preferably 80 to 100°.

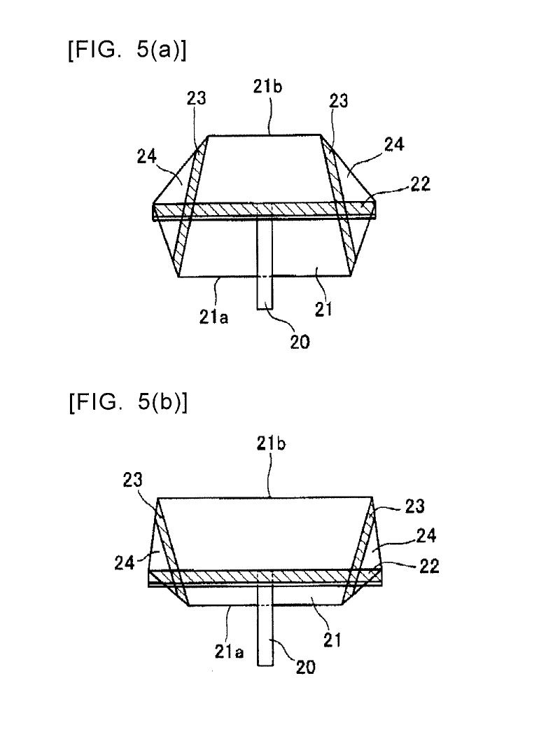

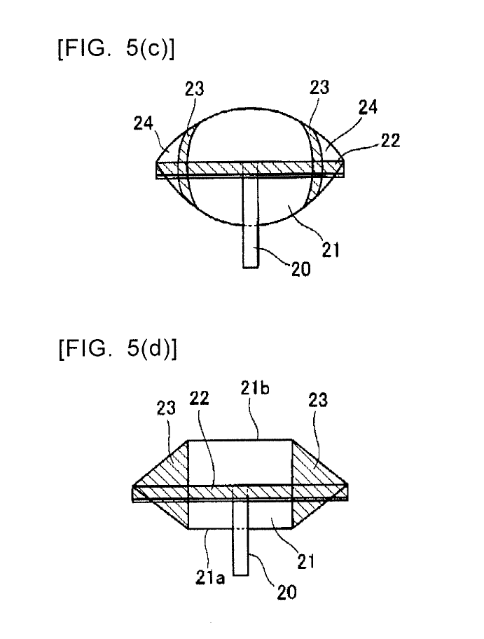

The shape of bottom face part 21 is not particularly limited to rectangle as shown in each of FIG. 2 and FIG. 3. FIGS. 5 (a) to 5 (d) are bottom views showing other embodiments of the bottom face part. As shown in each of FIGS. 5 (a) and 5 (b), the seal directions of the second sealing parts 23 are changed to the seal direction of the first sealing part 22 to make the shape of bottom face part 21 be a trapezoid. As shown in FIG. 5 (a), it can be a trapezoid in which side 21a of a front side is longer than side 21b of back side. As shown in FIG. 5 (b), it can be a trapezoid in which side 21a of a front side is shorter than side 21b of back side. Also, as shown in FIG. 5 (c), the shape of bottom face part 21 can be an approximately circular shape (or an approximately elliptic shape). When bottom face part 21 is set to an approximately circular shape (or an approximately elliptic shape), as shown in FIG. 5 (c), the shape of second sealing parts 23 can be a circular arc shape. In the above examples, corner portion 24 having the internal space is exemplified; however, as shown in FIG. 5 (d), whole of corner portion 24 can be sealed by second sealing part 23 to have no internal space.

If the area of the bottom face part of the container body in the present invention is smaller, the residue after discharging the content can be decreased. Especially, as explained in the below described fluid discharge method, when the bag of the present invention is mounted within the pressure container, it is preferable that the area of the bottom face part of the bag is almost equal to the bottom area of the inside of the pressure container. In such a case, it is more preferable that the shape of the bottom face part of the bag is approximately the same as or similar to that of the bottom inside of the pressure container, and the shape is not limited depending on usage of bag and great care and cost for making the bottom face part be the same shape.

Depending on usage, for example, the area of the bottom face part can be set to 100 to 1,000,000 mm².

### 1-2. Spout Tube

The spout tube of the present invention allows the inside of the container body to communicate with the outside the container body, and is interposed between the films that are matched at the first sealing part of the bottom face part. As described above, the spout tube is fixed in the position by the first sealing part, and functions to discharge the content inside of the bag to the outside of the bag. From the point of view that the content remaining in the bottom face part can be uniformly discharged to the outside of the bag, the spout tube is preferably provided at an approximately middle in the container body width direction of the first sealing part.

Further, the spout tube of the present invention is arranged in a plane which is approximately parallel to the flat bottom face part together with the first sealing part. As shown in FIG. 6, in bag 100, central axis 20b in the discharge direction of a content in spout tube 20 (hereinafter, may be referred to as a central axis of the spout tube) is approximately parallel to flat face of bottom face part 21.

Herein “the spout tube is arranged in a plane which is approximately parallel to the flat bottom face part” means that the angle made by the flat face of the bottom face part of the container body and the central axis of the spout tube is suitably 0 to 30°, more suitably 0 to 10°.

Also, the container body of the present invention is made of a flexible film, so that the bottom face part is not always a plane. In that case, it is enough for the present invention that the contact surface of the bottom face part and the central axis of the spout tube are approximately parallel.

Further, by arranging the central axis of the spout tube in a plane which is approximately parallel to the bottom face part of the container body, flow passage inlet of the spout tube inside of the container body is not opened upward in the vertical direction, and is preferably opened in a horizontal direction to the plane which is approximately parallel.

In the present invention, it is preferable that the first sealing part of the container body is folded in approximately parallel to the bottom face part, and has a crease. As described above, by folding the first sealing part which interposes a spout tube, the spout tube is fixed so that the central axis direction of the spout tube is approximately parallel to the flat surface of the bottom face part.

From the viewpoint of decreasing the amount of the content remaining in the spout tube as much as possible, the internal diameter of the spout tube is preferably small. Depending on the type of the content to be discharged, the internal diameter of the spout tube is preferably 20.0 mm or less, specifically. Also, from the viewpoint of decreasing the resistance when discharging the content, the internal diameter of the spout tube is preferably 5.0 mm or more. Herein, the resistance when discharging the content specifically refers to resistance calculated from the theory in which when internal diameter “x” is set to ½x, pressure “p” is set to 2⁴p to obtain equal flow rate, as assumed from Hagen-Poiseuille's law (Formula 1).

flow rate Q=k×(the fourth power of radius)×(pressure reduction) Formula (1)

The bag of the present invention is preferably used by being mounted inside the pressure container. The portion of the spout tube, which is projected to the outside of the container body, is mounted below the bottom face part of the container body, so that the material and thickness of the spout tube is selected from the point of view that they have durability to load of a content and pressure imparted to a pressure container. Especially, the material of the spout tube is preferably a material which can adhere to the inner surface of the container body, for example, resins such as polyethylene and polypropylene can be exemplified. The thickness of the spout tube is preferably 0.2 mm or more from the viewpoint of retainability of a tube shape, and is preferably 2.0 mm or less from the viewpoint of heat conductivity when sealing.

The shape of the spout tube in X-X cross-sectional view of FIG. 6 is preferably an approximately a linear shape, and can be curved to the extent that the effect of the present invention is interfered.

In the case that the spout tube is projected long to the inside of the container body, the content accumulated in the vicinity of a projected position of the spout tube is unlikely to be discharged. Therefore, it is preferable that the spout tube is not projected to the inside of the container body as much as possible. Specifically, the length in which the spout tube is projected to the inside of the container body is preferably 0 to 10 mm apart from the upper end edge of the first sealing part, that is, the boundary between the first sealing part and the inside of the bag.

The length of the spout tube which is projected to the outside of the container body is not particularly limited from the point of view that the length of the discharge flow passage can be appropriately extended depending on a discharge pipe outside the bag. The surface of the portion which is projected to the outside of the container body of the spout tube may be fixed by being adhered to the outer surface of the bottom face part of the container body.

The spout tube can be further connected to the discharge pipe outside of the bag through connecting members such as L-shaped pipe, etc. As described above, by appropriately extending a content flow passage using the discharge pipe outside of the bag, when the bag is arranged inside of a pressure container, the content can be discharged to the outside of the pressure container. Both of a flexible tube and a hard tube can be used for the discharge pipe outside of the bag.

### 1-3. Opening End of Bag Opposite to Side Where Spout Tube is Provided

Of opening ends in a cylindrical barrel portion made of a flexible film which forms a container body, an opening end, which is the side opposite to the side where a spout tube is provided, can be any shape, as long as it is closed. The opening end can be sealed similarly as the side where the spout tube is provided, or a flat face which can be an upper face part is provided similarly as the side where the spout tube is provided.

As shown in FIG. 1, at the side opposite to the side where the spout tube is provided, an inlet which charges a fluid in the bag can be provided. The shape of the inlet is not particularly limited, and a known shape can be employed.

### 1-4. Production Method of Bag

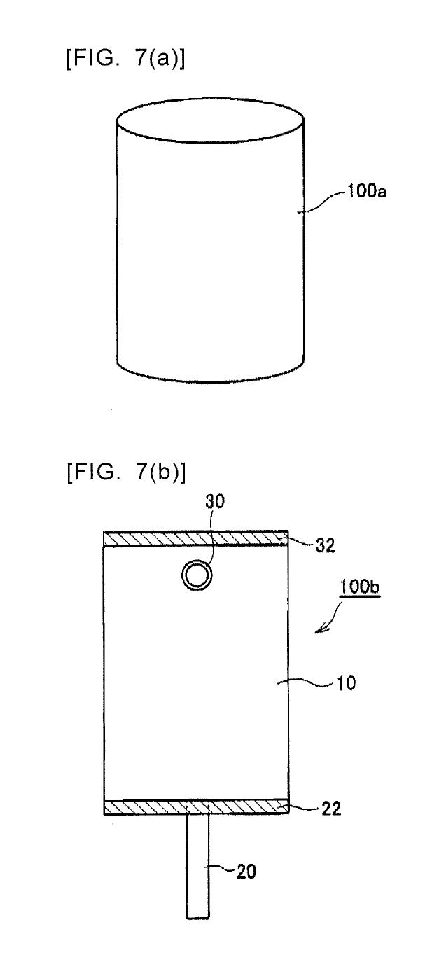

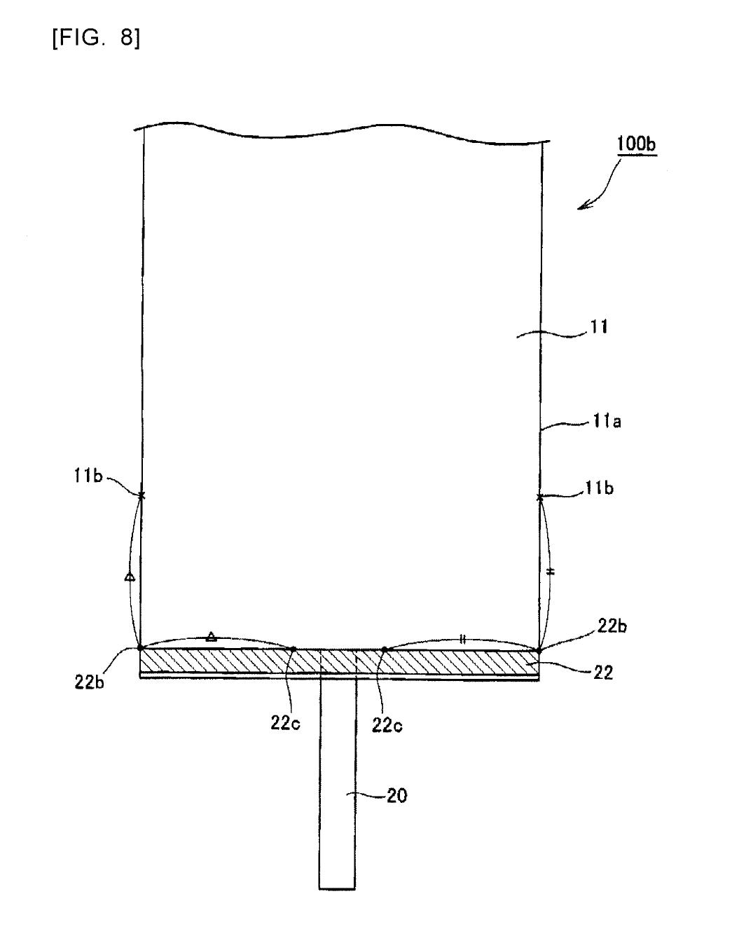

FIG. 7 (a) and FIG. 7 (b) are schematic views of the intermediate product in the typical example of the method for producing the bag of the present invention. For convenience for explaining the structure of each of intermediate products, the aspect ratio of the intermediate product and the scale of the spout tube and the inlet, which are shown in FIG. 7 (a) and FIG. 7 (b), are not necessarily corresponding to the aspect ratio and the scale of the actual intermediate product.

As the method for producing the bag, first, cylindrical body 100a made of a flexible film is prepared (FIG. 7 (a)). Flexible film cylindrical body 100a is preferably made of a seamless integrally-molded film. As the method for forming flexible film cylindrical body 100a, the above-described inflation molding, etc. are preferable.

Next, of the opening ends of flexible film cylindrical body 100a, one of the opening ends corresponding to the bottom face part of the bag is closed by providing first sealing part 22, so that bag-shaped container body 10 in which flexible film cylindrical body 100a can be a barrel portion is formed. In this case, first sealing part 22 is formed by interposing spout tube 20 is interposed between the films that are part to be first sealing part 22 and matched together, thus forming first sealing part 22. Spout tube 20 is preferably provided approximately at the middle in the container body width direction of the first sealing part 22. Also, inlet 30 is provided in the vicinity of the other of the opening ends of the flexible film cylindrical body, and further, the other opening end is closed by providing third sealing part 32, so that intermediate product 100b is produced (FIG. 7 (b)). Inlet 30 is preferably provided approximately at the middle in the container body width direction.

It is preferable that the seal direction of third sealing part 32 is approximately parallel to seal direction of the first sealing part 22.

The order of the formation of first sealing part 22, the formation of third sealing part 32, and the formation of inlet 30 is not particularly limited. In the method for producing the bag of the present invention, it is not necessarily to go through intermediate product 100b, third sealing part 32 and inlet 30 can be formed after forming a bottom face part. To the contrary, first sealing part 22 can be formed after forming an upper face part.

After forming first sealing part 22, bottom face part 21 is formed. The bottom face part of the present invention is preferably formed in a flat by folding a lower end of the barrel portion so as that an inner surface of a side edge of the barrel portion and an inner surface in the vicinity of the upper end edge of the first sealing part are in contact with each other and providing a second sealing part which is fixed in a folded state. As described above, the bottom face part of the present invention is preferably formed through (1) folding step and (2) sealing step of the second sealing part.

Specifically, the folding step described above comprises the steps of: setting a pair of positioning points respectively on each of corners in the width direction on the lower end of the barrel portion; and folding the vicinity of each of the corners on the lower end of the barrel portion so that these positioning points are overlapped.

FIG. 8 is a part of a magnified view of a front face of a lower side of the barrel portion of intermediate product 100b. As shown in FIG. 8, first, on each of corners of the lower end of the barrel portion, positioning point 22c on the first sealing part side is set at the position on the first sealing part, which is off from end 22b of the first sealing part toward the center in the width direction of the barrel portion by predetermined distance. Next, positioning point lib on the side edge side is respectively set upward in parallel to the axial direction of the barrel portion at the position on the side edge of the barrel portion, which is off to the distance from end 22b of the first sealing part to positioning point 22c on the first sealing part side.

The depth of folding, that is, the distance from end 22b of the first sealing part to positioning point 22c on the first sealing part side can be the same or different from both corners on the lower end of the barrel portion. The depth of folding defines the length and interval of the second sealing part. The depth of folding is deeper, the second sealing part can be longer, and the interval between the second sealing parts can be narrower.

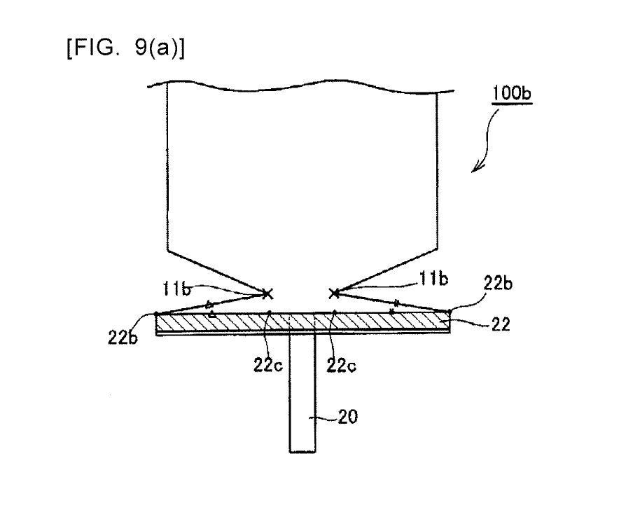

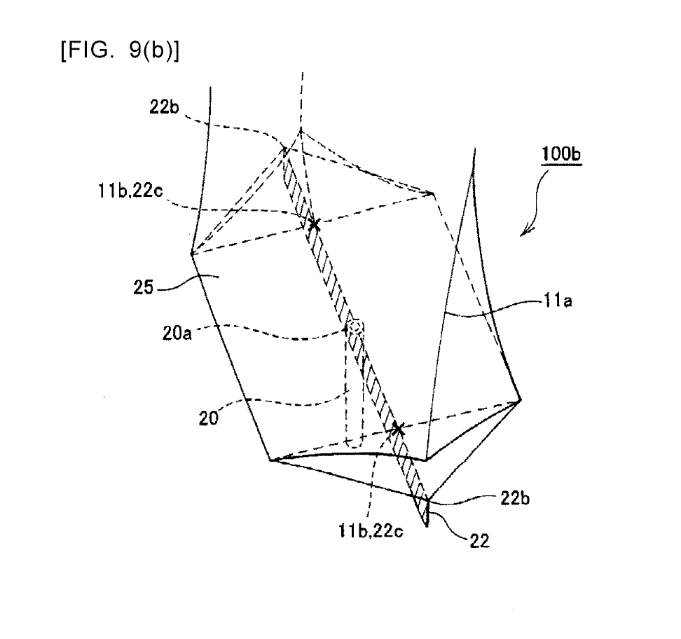

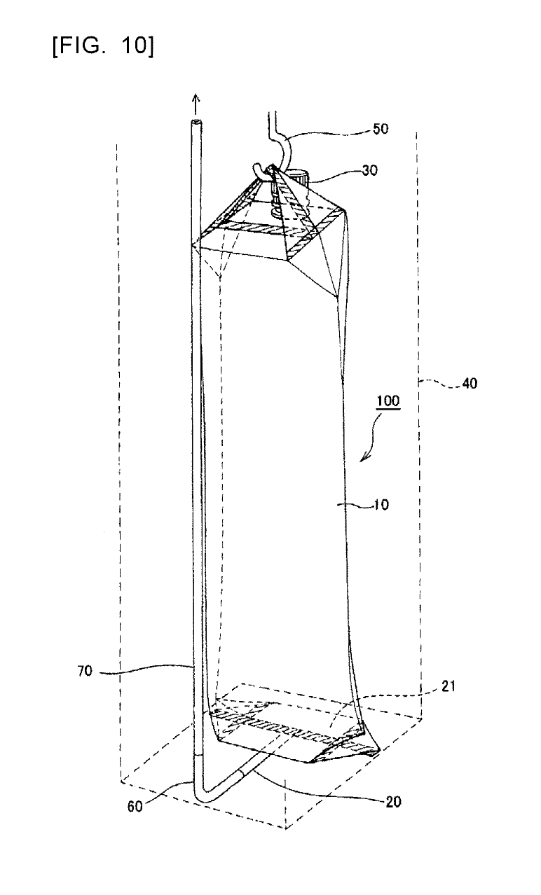

FIG. 9 is a part of a magnified view of a front face of a lower side of the barrel portion showing a state in which intermediate product 100b of FIG. 8 is folded according to positioning points (FIG. 9 (a)), and a part of a perspective view of a lower side of the barrel portion (FIG. 9 (b)). As shown in FIG. 9 (a), the side edge of the barrel portion is folded so that the inner surface in the vicinity of positioning point 22c on the first sealing part side are faced to the inner surface in the vicinity of positioning point 11b on the side edge side to overlap these two positioning points, thereby forming flat portion 25 of a flat hexagon having a face approximately vertical to an axial direction of the barrel portion as shown in FIG. 9 (b). In this step, spout tube 20 is still parallel and downward to the axial direction of the barrel portion.

Second sealing parts 23 which separate triangle-shaped corner portions 24 from an inner space of the container body are formed at both ends in the width direction so that two triangles are formed from hexagonal flat portion 25 as shown in FIG. 9 (b) at both ends, and a tetragon is formed between two triangles, thereby tetragonal bottom face part 21 is completed (FIG. 2). At this time, the second sealing part can be formed so as to pass through the position where positioning point 22c of the first sealing part side is superimposed on positioning point lib on the side edge side, and the second sealing part can be formed at a position near the end 22b side of the first sealing part compared with the position of the positioning point 22c on the first sealing part side and the positioning point 11b on the side edge side. The seal direction of the second sealing part can be a direction approximately vertical to the first sealing part as shown in FIG. 2, and can be appropriately selected in accordance with the shape of the bottom face part as shown in FIG. 5 (a) to FIG. 5 (d) described above.

When the second sealing part is formed, by folding the first sealing part so as to contact with a bottom face part, the first sealing part is folded approximately parallel to a bottom face part together with a spout tube. The state of the first sealing part and the spout tube before folding is shown in FIG. 9 (b) and the state after forming the bottom face part by folding the first sealing part is shown in FIG. 2, respectively.

The second sealing part is formed by intersecting the first sealing part. By forming the second sealing part by intersecting as described above, the second sealing part is formed over at least one point on the first sealing part. Thereby, the first sealing part is folded together with the spout tube so as to be along a face direction of a flat bottom face part, which resulted in having so-called a crease. Also, by intersecting the first sealing part with the second sealing part, the function of beam formed by the seal section described above is more exerted, thereby increasing the strength of the flat bottom face part.

On the other hand, after forming inlet 30 and third sealing part 32, upper face part 31 is formed. The upper face part 31 of the present invention is preferably formed in a flat symmetric to bottom face part 21 by folding so as that an inner surface of side edge 11a of the barrel portion and an inner surface in the vicinity of the lower end edge of third sealing part 32 are in contact with each other at each corner of the upper end of the barrel portion, and provide a fourth sealing part 33 fixed in a folded state. Herein, the lower edge of the third sealing part 32 refers to a boundary between the inside of container body 10 and third sealing part 32. The upper face part of the present invention is suitably formed through (1) folding step and (2) sealing step of the fourth sealing part similarly as the bottom face part.

### 1-5. Advantageous Effects Provided by Bag of the Present Invention

As described above, the bag has a flat bottom face part, and further, the spout tube is provided so as to be approximately parallel to the flat face of the bottom face part. Therefore, unlike the discharge device of a viscous product disclosed in Patent Literature 2, it is unnecessary to provide a space for which the spout tube is arranged downward in a vertical direction on the lower side of the bag in the pressure container, so that space saving is achieved. Further, when residual amount of the content is small, there is no space for which a flexible film constituting a container body is hung down and dropped below the flow passage inlet of the spout tube arranged inside of the container body, so that no content remains in the dropped part differently from Patent Literature 2, thereby the residue in the bag can be decreased than before. Also, by using the flat bottom face part of the container body, the bag can be used by mounting in the pressure container.

Also, the central axis of the spout tube is approximately parallel to the flat face of the bottom face part of the container body, and the flow passage inlet inside of the container body is not opened upward, so that even if the flexible films of the barrel portion in the container body are adhered each other in the middle of the content discharge, and the residual amount of the content is decreased to the extent that the flexible film is sagged, the flow passage inlet of the spout tube can discharge the content without being covered from the upper side with the sagging flexible film, thereby the residual amount of the content after discharge can be decreased. Furthermore, as the method for discharging a fluid, in the case that the end of the spout tube outside of the container body is connected to the L-shaped connecting member, the connecting member is connected to the discharge pipe outside of the bag, and the flow passage is pulled up to the upper portion of the pressure container using the discharge pipe outside of the bag, then the fluid is discharged from the upper portion of the pressure container, the spout tube is provided so as to be approximately parallel to the flat face of the bottom face part of the container body, therefore, the direction of the content flow passage is only changed once from a horizontal direction to an upward direction. Thereby, the content is less likely to remain in the passage.

### 1-6. Use of Bag

The bag of the present invention can be used for the method for discharging a fluid such as liquid, etc. by applying pressure in the pressure container, as described above. The bag of the present invention exhibits effects especially as: containers for the discharge of liquid compositions such as glue and adhesive, which are likely to remain in a device and are difficult to be removed from the device; containers for the transfer by discharging the solution of pharmaceutical products or row materials thereof in the pharmaceutical industry; and containers for inspecting filters which are used up especially in pharmaceutical product manufacturing. This is because, in the case of discharging these liquids, the residual amount is extremely and severely judged.

When the liquid compositions which are likely to remain in the pressure container are discharged, the remaining liquid composition is solidified by drying and curing, so that the removal of the remaining liquid composition is extremely difficult, and then the physical work such as scraping is required. In such a case, these liquid compositions are filled in the bag of the present invention and discharged by applying pressure from the outside of the bag in the pressure container, and then the bag itself is disposed after discharge. Such a work in which the bag of the present invention is used by replacing every time of the work is extremely useful.

In the pharmaceutical industry, when different kinds of pharmaceutical products are alternately produced in the same device, the cross contamination of the different kinds of pharmaceutical products is not permitted. This is the same as the used solution for inspecting filters which is used up in pharmaceutical product manufacturing, which requires strictness, and the validation of the washing method is performed to show that there is no cross contamination caused. If the disposable container is not used, washing at every use is required from the viewpoint of avoiding such a cross contamination. In pharmaceutical industry, in general, there are many cases that pharmaceutical products produced or the raw materials thereof are expensive substance, so that it is beneficial to collect and recover even a very small amount of the pharmaceutical products produced or the raw materials thereof, and if those are not collected and recovered, which results in a loss. As described above, in pharmaceutical industry, process cost and financial cost due to loss of pharmaceutical products or the raw materials thereof are extremely high. In such a pharmaceutical industry, it is necessary to avoid pharmaceutical products or the raw materials thereof from remaining in the pressure container; therefore, pharmaceutical products or the raw materials thereof are filled in the bag of the present invention and discharged by applying pressure from the outside of the bag in the pressure container, and then the bag itself is disposed after discharge. Such a work in which the bag of the present invention is used by replacing every steps is extremely useful.

### 2. Fluid Discharge Method

The fluid discharge method of the present invention comprises the steps of: filling the bag with a fluid; disposing the bag so that the bottom face part of the bag is arranged on the lower side of a vertical direction in a pressure container, and an end of the spout tube or an end of an extension tube which is connected to the spout tube, is drawn out to the outside of the pressure container; and applying pressure from the outside of the bag by applying pressure to the inside of the pressure container, thus discharging the fluid from the bag to the outside of the pressure container.

The fluid filled in the bag in the present invention is not particularly limited, as long as it has flowability, and refers to a liquid, a viscous substance, etc. The liquid include a liquid containing gas, a liquid and a solid. Among the fluid, the fluid discharge method of the present invention is preferably used for discharging especially a liquid, a liquid containing a solid, and a viscous substance, and is more preferably used for discharging a liquid and a liquid containing a solid.

In the present invention, the fluid to be filled in the bag is not particularly limited. The examples include a fluid such as glue, adhesive, coating material and coating agent, which are industrially used and are difficult to be removed when the fluid remains in the pressure container, pharmaceutical products in pharmaceutical industry or a solution of the raw materials of the pharmaceutical products, and solution for inspecting filters which are used up in pharmaceutical product manufacturing.

FIG. 10 is a schematic perspective view showing an example of a fluid discharge method of the present invention. Bag 100 comprising container body 10, spout tube 20 and inlet 30 corresponds to bag 100 shown in FIG. 1. Particularly not shown in figures, fluid such as a liquid is filled in bag 100.

Bag 100 is disposed in pressure container 40 so that the bottom face part of bag 100 is arranged on the lower side of a vertical direction. In FIG. 10, pressure container 40 is referred as dashed line.

The pressure container used in the present invention is not particularly limited, and a known pressure container can be used. For example, a sealable pressure container such as autoclave, etc. can be used. The pressure container can comprise an upper lid part (not shown) of the pressure container fixed by a known fixing system. In that case, the bag which is filled with a fluid being a content is housed inside of the pressure container by opening the upper lid part.

The pressure container comprises a gas supply pipe (not shown), and the inside of the pressure container is pressurized by gas provided from a gas supply device such as a compressor. In that case, air pressure inside of the pressure container can be confirmed using a pressure gauge. Gas which is supplied into the pressure container is not particularly limited, and the examples include air, etc.

In the pressure container, hole (not shown) for introducing a discharge pipe outside of the bag to the outside of the pressure container is provided.

In the present invention, the bag is disposed so that an end of the spout tube or an end of an extension tube which is connected to the spout tube (discharge pipe outside of bag) is drawn out to the outside of the pressure container.

As shown in FIG. 10, discharge pipe 70 outside of the bag is connected to the end of spout tube 20 of bag 100 outside of the container body through L-shaped connecting member 60. As described above, through L-shaped connecting member 60, a fluid flow passage which is directed to an approximately horizontal direction by spout tube 20 can be introduced to the upper portion of the pressure container by discharge pipe 70 outside the bag, so that the fluid can be discharged from the upper portion of pressure container 40. When the bag is arranged in the pressure container or the fluid is charged into the bag from inlet 30, from the viewpoint of preventing a fluid leakage, if necessary, valve or cock for temporarily stopping a fluid discharge can be provided on a flow passage after the spout tube.

The method for arranging the bag inside of the pressure container is not particularly limited, as long as the bottom face part of the bag is disposed on the lower side. The bag can be mounted or hung inside of the pressure container. Among the above, as shown in FIG. 10, the method for hanging bag 100 using hook 50 provided on the upper portion of pressure container 40 is preferable.

Also as shown in FIG. 10, bottom face part 21 of the bag is preferably in contact with the bottom of pressure container 40. In such a state, the bag in which the content is filled is held inside of a pressure container at three points: the bottom of the pressure container; hook 50 provided on the upper portion of the pressure container; and discharge pipe 70 outside the bag. Even if the content is discharged by applying pressure, the deformation of the shape of the bag, especially the shape of the bottom face part, can be prohibited. Therefore, in the last stage of the fluid discharge, the flexible film which forms the container body is not hung down below the bottom face part, so that no content remains below the flow passage inlet of the spout tube inside of the container body. Also, by arranging the bottom face part of the bag in contact with the bottom of the pressure container as described above, an extra space which is produced below the bottom face part of the bag, that is, a space in which the flexible film which forms the container body is hung down and sink down can be preliminarily eliminated.

The method for hanging the bag is not particularly limited, and the examples include a method for hanging the bag inside of the pressure container by passing a hook through a hanging hole provided on the third sealing part of the upper end of the bag, and the method for hanging the bag inside of the pressure container by passing a hook through a handle formed by sticking triangle corner portions on the upper end of the bag as shown in FIG. 10.

As described above, pressure is applied from the outside of the bag disposed inside of the pressure container by applying pressure to the inside of the pressure container, and thus a fluid in the bag is discharged to the outside of the pressure container. The pressure applied by the pressure container can be appropriately adjusted in accordance with the material of the bag, the filling amount and viscosity of the fluid, and the discharge speed and discharge amount of the fluid.

In the bag of the present invention, the spout tube is disposed in a plane which is approximately parallel to the flat bottom face part. Therefore, in the fluid discharge method of the present invention, when a fluid is discharged from the upper portion of the pressure container, the direction of the fluid flow passage is only changed once upward in the vertical direction from the approximately horizontal direction; therefore, there is an advantage that the fluid is less likely to remain in a direction changing part.

### EXAMPLES

Hereinafter, the present invention will be described in detail, by way of examples and comparative examples. The scope of the present invention is not limited by the examples.

### 1. Production of Bag

### Example 1

Using a multilayer inflation film molding machine, a cylindrical body made of a laminated film was formed, comprising a heatseal layer made with polyethylene as an innermost layer and a layer made with polyamide as an outermost layer. The folded width of the film cylindrical body was 216 mm, and the obtained film thickness was 250 μm. The film cylindrical body was cut into the length of about 750 mm, an inlet was provided on the upper portion of the film cylindrical body, and then the upper end of the film cylindrical body was sealed to form a third sealing part.

A spout tube (material: polyethylene, internal diameter: 6.35 mm, external diameter: 9.525 mm, length: 100 mm) was interposed at the middle in the width direction between the films that are matched at the lower ends of the film cylindrical body, and the lower ends of the film cylindrical body were sealed so as to include the interposed part to form a first sealing part.

Next, a lower end of the barrel portion is folded so as that an inner surface of a side edge of the barrel portion and an inner surface in the vicinity of the upper end edge of the first sealing part were in contact with each other. By folding as described above, a hexagonal flat portion having a face which was vertical to an axial direction of the barrel portion was appeared. The second sealing parts which separate triangle-shaped corner portions from an inner space of the container body were formed at both ends in the width direction so that two triangles were formed from the hexagonal flat portion at both ends, and a tetragon was formed between two triangles, thereby tetragonal flat bottom face part was completed. When forming the bottom face part, the first sealing part containing the part in which the spout tube was interposed was folded in approximately parallel to the flat bottom face part so that the direction of the spout tube was directed to approximately parallel to the bottom face part.

By going through the above steps, the bag in Example 1, in which the bottom face part of the container body was flat and the first sealing part and the spout tube were disposed in a plane which was approximately parallel to the flat bottom face part, was produced.

### Comparative Example

The same cylindrical body made of a laminated film (folded width: 216 mm, film thickness: 250 μm) as used in the production of the bag in Example 1 was used. The film cylindrical body was cut into the length of about 750 mm, an inlet was provided on the upper portion of the film cylindrical body, and then the upper end of the film cylindrical body was sealed to form a third sealing part. On the lower portion of the film cylindrical body, the spout tube (material: polyethylene, internal diameter: 6.35 mm, external diameter: 9.525 mm, length: 20 mm) was interposed between seal sections and sealed to form the first sealing part, thereby producing a bag.

That is, in the bag of Comparative Example 1, no flat bottom face part is provided, the direction of the spout tube is parallel to the axial direction of the barrel portion of the film cylindrical body, and the flow passage inlet inside of the container body is opened upward.

### 2. Evaluation of Liquid Discharge

By filing a colloidal gold solution in each of the bag bodies in Example 1 and Comparative Example 1, discharging the colloidal gold solution by applying pressure in the pressure container, and passing the colloidal gold solution through a virus removal filter (hereinafter, may be referred to as a filter), the discharge speed (filtration rate in the filter) of the colloidal gold solution and the amount of the colloidal gold solution remaining in the bag were evaluated. Such a test in which the colloidal gold solution is filtered with a filter simulates a test for evaluating the integrity of the filter used in the step of producing a biological formulation (that is, property of not changing the pore diameter of the filter after and before usage). The detail is as follows.

First, 4 L of a colloidal gold solution was filled in each of bags in Example 1 and Comparative Example 1 from each inlet, and then each the inlet and the opening on the outer side of the container body of the spout tube were closed to seal. Next, a discharge pipe outside of the bag was connected to the opening on the outer side of the container body of the spout tube in each of the bags through a connecting member, so that the end of the discharge pipe outside of the bag was introduced to the upper side of the vertical direction. The connecting members used at this time were an L-shaped pipe in the bag in Example 1, and a U-shaped tube in the bag in Comparative Example 1. Next, each of the bags containing the colloidal gold solution was arranged inside of the pressure container. At this time, the bag in Example 1 was hung so that the bottom face part of the container body, the spout tube and the L-shaped pipe were in contact with the bottom in the pressure container, and the bag in Comparative Example 1 was hung so that the U-shaped tube being the connecting member is in contact with the bottom in the pressure container. Then, the discharge pipe outside of the bag was connected through the connecting member connected to each of the bags to introduce the end of the discharge pipe from the upper portion of the pressure container to the outside of the pressure container.

At the outside of the pressure container, the end of each of the discharge pipes outside of the bag was connected to a filter. By increasing pressure inside of the pressure container to apply pressure to the bag, the colloidal gold solution was filtered with a filter.

The filtration rate of the colloidal gold solution discharged from the bag in Example 1 was substantially constant in the range from 2.5 L/min to 3.0 L/min during the filtration, and the flow passage was not clogged during the filtration. After the discharge of the colloidal gold solution from the bag in Example 1 was terminated, the residual amount of the colloidal gold solution inside of the bag was measured, and was extremely small amount (32 mL) (0.8% to 41 of filling amount of colloidal gold solution, 0.5% to 6.5 L of capacity of bag).

On the other hand, the filtration rate of the colloidal gold solution discharged from the bag in Comparative Example 1 was 2.5 L/min to 3.0 L/min in the beginning of the filtration; however, the filtration rate was decreased in the middle of the filtration and was decreased to 0.1 L/min in the end. After the discharge of the colloidal gold solution from the bag in Comparative Example 1 was terminated, the inside of the pressure container was checked and then confirmed that the film which forms the container body covered the flow passage inlet side of the spout tube. In addition, the residual amount of the colloidal gold solution in the bag was measured and was an unignorable amount (198 mL) (4.95% to 4 L of filling amount of colloidal gold solution, 3.05% to 6.5 L of capacity of bag).

As described above, compared to the bag of Comparative Example 1 merely provided with a flat bag-shaped lower end sealed by bonding with a spout tube, in the bag of Example 1 comprising a flat bottom face part, the residual amount of the colloidal gold solution after discharge was decreased to one sixth of that of Comparative Example 1. Also, in the bag of Comparative Example 1 in which the spout tube is parallel to an axial direction of the barrel portion, after discharging the colloidal gold solution, the film covered the flow passage inlet side of the spout tube. On the other hand, in the bag of Example 1 in which the direction of the spout tube is approximately parallel to the bottom face part, such a sagging of the film was not confirmed and the flow passage inlet was not shut down. Furthermore, in order to discharge the fluid from the upper portion of the pressure container, in the bag of Comparative Example 1 in which the opening of the spout tube on the outer side of the container body is directed to the lower side in the axial direction of the barrel portion, the flow direction of the colloidal gold solution discharged from the bag was changed by 180 degrees, so that the colloidal gold solution was stagnated in the flow passage and the filtration rate was decreased to 4% or less of the beginning of the filtration. However, in the bag of Example 1 in which the direction of the spout tube was approximately parallel to the bottom face part, the outlet of the spout tube was directed to the horizontal direction, so that the flow direction of the colloidal gold solution discharged from the bag was changed only by 90 degrees; therefore, the colloidal gold solution was not stagnated in the middle of the flow passage and thus the filtration rate was kept constantly to the end of the discharge.

### REFERENCE SIGNS LIST

10. Container body
11. Barrel portion
11a. Side edge of barrel portion
11b. Positioning point on side edge side
20. Spout tube
20a. Flow passage inlet of spout tube inside of container body
20b. Dashed line showing central axis of spout tube
21. Bottom face part
21a. Side which can be boundary of lower portion of front face of barrel portion and bottom face part
21b. Side which can be boundary of lower portion of back face of barrel portion and bottom face part
22. First sealing part
22a. Upper end edge of first sealing part
22b. End of first sealing part
22c. Positioning point on first sealing part
23. Second sealing part
24. Corner portion
25. Hexagonal flat portion
30. Inlet
31. Upper face part
32. Third sealing part
33. Fourth sealing part
40. Pressure container
50. Hook
60. L-shaped connecting member
70. Discharge pipe outside of bag
100. Bag
100a. Cylindrical body made of flexible film
100b. Intermediate product

1. A bag comprising a bag-shaped container body which is made of a flexible film, and a spout tube which allows the inside of the container body to communicate with the outside the container body,
wherein the container body comprises: a cylindrical barrel portion; a first sealing part which is formed at a lower end of the barrel portion by matching and sealing together inner surfaces of the film constituting the container body; and a flat bottom face part including an upper end edge of the first sealing part;
wherein the spout tube is interposed between the films that are matched at the first sealing part of the bottom face part; and
wherein the first sealing part and the spout tube are disposed in a plane which is approximately parallel to the flat bottom face part.

2. The bag according to claim 1, wherein the first sealing part is folded in approximately parallel to the bottom face part.

3. The bag according to claim 1, wherein the flat bottom face part is formed by folding a lower end of the barrel portion so as that an inner surface of a side edge of the barrel portion and an inner surface in the vicinity of the upper end edge of the first sealing part are in contact with each other and providing a second sealing part which is fixed in a folded state.

4. The bag according to claim 3, wherein a sealing direction of the second sealing part is approximately vertical to a sealing direction of the first sealing part.

5. The bag according to claim 1, wherein the barrel portion is made of a seamless integrally-molded film.

6. The bag according to claim 1, wherein the spout tube is provided approximately at the middle in a container body width direction of the first sealing part.

7. A fluid discharge method comprising the steps of: filling the bag defined by claim 1 with a fluid; disposing the bag so that the bottom face part of the bag is arranged on the lower side of a vertical direction in a pressure container, and an end of the spout tube or an end of an extension tube which is connected to the spout tube is drawn out to the outside of the pressure container; and applying pressure from the outside of the bag by applying pressure to the inside of the pressure container, thus discharging the fluid from the bag to the outside of the pressure container.
